(19) United States
(12) Patent Application Publication
(10) Pub. No.: US 2025/0061736 A1
(43) Pub. Date: Feb. 20, 2025

(54) NOTE GENERATING METHOD AND RELATED DEVICE THEREOF

(71) Applicant: HUAWEI TECHNOLOGIES CO., LTD., Shenzhen,Guangdong (CN)

(72) Inventors: Zhenyi He, Shenzhen (CN); Zhirong Xue, Shenzhen (CN)

(73) Assignee: HUAWEI TECHNOLOGIES CO., LTD., Shenzhen,Guangdong (CN)

(21) Appl. No.: 18/723,870

(22) PCT Filed: Dec. 26, 2022
(86) PCT No.: PCT/CN2022/141933

§ 371 Date: Jun. 25, 2024

(30) Foreign Application Priority Data
Dec. 28, 2021 (CN) 202111633089.1
Dec. 21, 2022 (CN) 202211648463.X

(51) Int. Cl. G06V 30/146; G06F 3/04883; G06V 30/262

(52) U.S. Cl. CPC G06V 30/147; G06F 3/04883; G06V 30/262

(57) ABSTRACT

In a note generating method, a terminal device obtains a target text area in a first image frame, wherein the target text area is a text area being read by a user. The terminal device converts a first drawn line in the target text area into a first detection area, which is used to identify a text area marked by the first drawn line. The terminal device then identifies a text area in the first detection area to obtain a user note.

This application claims priorities to Chinese Patent Application No. 202111633089.1, filed with the China National Intellectual Property Administration on Dec. 28, 2021 and entitled “NOTE GENERATING METHOD AND RELATED DEVICE THEREOF”, and to Chinese Patent Application No. 202211648463.X, filed with the China National Intellectual Property Administration on Dec. 21, 2022, and entitled “NOTE GENERATING METHOD AND RELATED DEVICE THEREOF”, both of which are incorporated herein by reference in their entireties.

### TECHNICAL FIELD

This application relates to the field of image processing technologies, and in particular, to a note generating method and related devices for the note generating method.

### BACKGROUND

The optical character recognition (optical character recognition, OCR) technology is an important technology in the image processing field, and can identify a text area in an image, to extract text information.

The OCR technology can be used to identify not only a text area of a single image, but also a text area that appears in a video stream. For example, it is assumed that a user is reading a book, the user is interested in a part of content in the book, and the user needs to record a corresponding note on a terminal device. In this case, the user may photograph the book by using the terminal device to obtain a video stream. Then the terminal device may identify an image frame in the video stream, to obtain the user note.

To accurately capture the content that the user needs to record, the user needs to manually adjust a camera of the terminal device, so that a field of view of the camera just presents that part of content. In this case, content presented in a text area of a captured image frame is the content that the user needs to record. After identifying the content, the terminal device may extract the content as the user note. However, in this note generating manner, the user needs to perform plenty of manual operations, resulting in poor user experience.

### SUMMARY

Embodiments of this application provide a note generating method and related devices for the note generating method, which provide a new note generating manner. A user only needs to complete a line drawing operation, with a very small quantity of operations to be performed, and the user does not need to spend too much time, thereby improving user experience.

According to a first aspect of embodiments of this application, a note generating method is provided. The method includes:
a first image frame obtained from a video stream by a terminal device may include a plurality of text areas, and then the terminal device may obtain a target text area from the plurality of text areas in the first image frame, where the target text area is a text area being read by a user; and it needs to be noted that, because the target text area is a text area being read by the user and the terminal device may perform an identification operation on the target text area to generate a user note, the target text area may also be understood as a text area (on which an identification operation is to be performed) to be identified by the terminal device;
after determining the target text area, the terminal device may identify a first drawn line (which may also be referred to as a user-drawn line) in the target text area; after identifying the first drawn line, the terminal device may convert the first drawn line into a first detection area, where the first detection area is usually a rectangular area, and identifies a text area marked by the first drawn line; and
after obtaining the first detection area, the terminal device may perform OCR on a text area in the first detection area, that is, extract, as a user note, a text presented in a text area enclosed by the first detection area.

It can be learned from the foregoing method that, after obtaining a text area that is in a first image frame and that is being read by a user, that is, after obtaining a target text area in the first image frame, a terminal device may identify a first drawn line entered by the user in the target text area, and convert the first drawn line in the target text area into a first detection area. Then the terminal device may perform OCR on a text area in the first detection area, to obtain a user note. In the foregoing process, the terminal device may intelligently convert the user-input first drawn line into the first detection area that identifies a text area marked by the first drawn line, to perform OCR on this part of text area in a targeted manner, to generate a note required by the user. It can be learned that, in this note generating manner, the user only needs to complete a line drawing operation, with a very small quantity of operations to be performed, and the user does not need to spend too much time, thereby improving user experience.

In a possible implementation, the converting a first drawn line in the target text area into a first detection area includes: creating a plurality of first rectangles that overlap with the first drawn line in the target text area, where the plurality of first rectangles are sequentially stacked; creating a second drawn line in a first rectangle with a largest overlapping degree, where the second drawn line is parallel to a long side of the first rectangle with the largest overlapping degree; and creating a second rectangle based on the second drawn line, where the second rectangle is used as the first detection area, the second drawn line is located in the second rectangle, the second drawn line is parallel to a long side of the second rectangle, and a length of a short side of the second rectangle is greater than a row height of the target text area. In the implementation, the terminal device first creates a plurality of first rectangles that overlap with the first drawn line in the target text area, where the plurality of first rectangles are sequentially stacked. For any first rectangle, there is a degree of overlapping between the first rectangle and the first drawn line, and the overlapping degree indicates a size of a part that is of the first drawn line and that is in the first rectangle. Then the terminal device selects, from the plurality of first rectangles, a first rectangle with a largest overlapping degree, and creates a second drawn line in the first rectangle with the largest overlapping degree. It needs to be noted that, the second drawn line is usually a straight line, the second drawn line may be located at a central point (or around the central point) of the first rectangle with the largest overlapping degree, and the second drawn line is parallel to a long side of the first rectangle with the largest overlapping degree. Finally, the terminal device creates a second rectangle based on the second drawn line, where the second rectangle may serve as the first detection area used to implement OCR. It needs to be noted that, the entire second drawn line is located in the second rectangle, the second drawn line is located slightly below a central point of the second rectangle, the second drawn line is parallel to a long side of the second rectangle, and a length of a short side of the second rectangle is greater than a row height of the target text area. It can be learned that, based on this manner, a size of the first detection area may be effectively determined, so that the created first detection area can enclose the text area marked by the first drawn line.

In a possible implementation, after the creating a second rectangle based on the second drawn line, the method further includes: dividing the second rectangle into a plurality of sub-rectangles; and removing, from the plurality of sub-rectangles, a sub-rectangle whose pixel proportion is less than a preset first threshold, and using a third rectangle formed by remaining sub-rectangles as the first detection area. In the implementation, the terminal device divides the second rectangle into a plurality of sub-rectangles, where an area enclosed by each sub-rectangle may be considered as a row of pixels in a text area enclosed by the second rectangle. In this case, in the plurality of sub-rectangles, areas enclosed by some sub-rectangles are blank rows, and areas enclosed by the other sub-rectangles are valid rows. After obtaining the plurality of sub-rectangles, for any sub-rectangle, the terminal device may perform computing based on all pixels in the sub-rectangle, to obtain a pixel proportion of the sub-rectangle. In this way, pixel proportions of all the sub-rectangles may be obtained. The terminal device divides all the sub-rectangles into two parts by presetting a first threshold. Pixel proportions of a first part of the sub-rectangles are less than the preset first threshold, and pixel proportions of a second part of the sub-rectangles are greater than or equal to the preset first threshold. Then the terminal device may remove the first part of the sub-rectangles, and use the second part of the sub-rectangles to form a third rectangle, which is to be used as the first detection area to finally implement OCR. It can be learned that, after optimizing the second rectangle, the terminal device may obtain a third rectangle. Compared with the second rectangle, the third rectangle eliminates an unnecessary part, so that a size is reduced, thereby effectively reducing an amount of computing required for subsequent OCR.

In a possible implementation, the obtaining a target text area in the first image frame includes: if state information about text areas in the first image frame is different from state information about text areas in a second image frame, determining the target text area in the first image frame based on the state information about the text areas in the first image frame, where the second image frame is an image frame previous to the first image frame. In the implementation, if the state information about the text areas in the first image frame is different from the state information about the text areas in the second image frame, it indicates that, compared with the second image frame, at least one of the plurality of text areas in the first image frame has changed. Therefore, the terminal device may perform further analysis based on the state information about the text areas in the first image frame, to determine the target text area in the plurality of text areas in the first image frame.

In a possible implementation, the state information about the text areas in the first image frame includes at least one of the following: a quantity of the text areas in the first image frame, sizes of the text areas in the first image frame, angles of the text areas in the first image frame, locations of the text areas in the first image frame, and the like; and the state information about the text areas in the second image frame includes at least one of the following: a quantity of the text areas in the second image frame, sizes of the text areas in the second image frame, angles of the text areas in the second image frame, locations of the text areas in the second image frame, and the like.

In a possible implementation, the determining the target text area in the first image frame based on the state information about the text areas in the first image frame includes: if there is a human body area of the user in the first image frame, it indicates that a part of the human body of the user is on a desk. In this case, whether the part of the human body of the user has opened a new book between a current moment and a previous moment may be further analyzed. Therefore, the terminal device may compare whether a quantity of text areas in the first image frame is the same as a quantity of text areas in the second image frame, to detect whether a new text area exists in the first image frame. If the quantity of text areas in the first image frame is different from the quantity of text areas in the second image frame, that is, compared with the second image frame, a new text area exists in the first image frame, it indicates that the user has opened a new book on the table, and, very probably, the user is reading the new book. In this case, an area occupied by a page of the new book in the first image frame is the new text area. Therefore, the terminal device may directly determine the new text area as the target text area. If the quantity of text areas in the first image frame is the same as the quantity of text areas in the second image frame, that is, compared with the second image frame, there is no new text area in the first image frame, it indicates that the user does not open any new book on the desk. In this case, a book associated with the part of the human body of the user may be regarded as a book that is being read by the user among a plurality of books on the desk. Therefore, the terminal device determines a text area associated with the human body area as the target text area. If there is no human body area of the user in the first image frame, it indicates that no any part of the human body of the user is on the desk. Therefore, static analysis may be directly performed on the plurality of books on the desk, to determine which book is being read by the user. In other words, the terminal device may determine, in the plurality of text areas in the first image frame, a text area with a largest semantic size as the target text area. For any text area, a semantic size of the text area is a ratio of a size of the text area to a semantic distance of the text area, where the semantic distance of the text area is a distance between the text area and a central point of the first image frame. In the implementation, the terminal device may determine a user intention in real time, that is, track in real time, in the first image frame, a text area being read by the user. In this way, the terminal device does not need to process all text areas in the first image frame, thereby improving precision and speed of information extraction.

In a possible implementation, a second detection area further exists in the target text area, the second detection area is obtained by converting a third drawn line in a third image frame, the third image frame is previous to the first image frame, and a plurality of image frames exist between the third image frame and the first image frame; and the identifying a text area in the first detection area to obtain a user note includes: if a distance between the text area in the first detection area and a text area in the second detection area is greater than or equal to a preset second threshold, respectively identifying the text area in the first detection area and the text area in the second detection area to obtain two user notes; or if a distance between the text area in the first detection area and a text area in the second detection area is less than a preset second threshold, merging the first detection area and the second detection area into a third detection area, and identifying a text area in the third detection area to obtain the user note. In this manner, the terminal device may perform intention identification on a plurality of text areas marked by drawn lines, and determine, based on spatial information (a distance) between the plurality of text areas, whether texts in the plurality of text areas are a same note. If the texts in the plurality of text areas are a same note, only one user note is generated; or if the texts in the plurality of text areas are not a same note, a plurality of different user notes are generated. This facilitates integration of note information, facilitates reading by the user, and further improves user experience.

In a possible implementation, after the respectively identifying the text area in the first detection area and the text area in the second detection area to obtain two user notes, the method further includes: merging the two user notes to obtain a new user note, where the two user notes are located in a same paragraph, and the new user note includes other texts other than the two user notes in the paragraph and the two user notes that are highlighted. In the implementation, after it is determined that texts in the plurality of text areas are a plurality of different notes, a plurality of generated notes may be merged. In this way, a plurality of line drawing manners can be implemented for the user, for example, a manner of continuous line drawing and a manner of scattered line drawing in a same paragraph are supported, so that functions of the solution are more comprehensive, to further improve user experience.

In a possible implementation, before the identifying a text area in the first detection area to obtain a user note, the method further includes: correcting the text area in the first detection area to obtain a corrected text area; and the identifying a text area in the first detection area to obtain a user note includes: identifying the corrected text area to obtain the user note. In the implementation, if an angle of the text area in the first detection area is not zero degrees, it indicates that the text area in the first detection area is distorted rather than facing a camera. In this case, the terminal device may adjust the angle of the text area in the first detection area until the angle is zero degrees, to obtain a corrected text area, and then the terminal device performs OCR on the corrected text area, thereby improving OCR speed.

In a possible implementation, a target symbol exists in the target text area, and after the identifying a text area in the first detection area to obtain a user note, the method further includes: if the target symbol is included in a preset symbol set, adding the user note to a user note set corresponding to the target symbol; or if the target symbol is not included in the symbol set, adding the target symbol to the symbol set, creating a user note set corresponding to the target symbol, and then adding the user note to the user note set corresponding to the target symbol. In the implementation, in the first image frame, probably there is not only the first drawn line entered by the user but also a target symbol entered by the user in the target text area, the target symbol is usually located near the text area marked by the first drawn line, and the target symbol corresponds to a type of user notes, that is, a user note set. In this case, after the text area in the first detection area is identified to obtain the user note, the terminal device may first detect whether the target symbol is in a preset symbol set. If the target symbol is in the symbol set, it indicates that the target symbol is a defined symbol. The terminal device adds the user note to a user note set corresponding to the target symbol. If the target symbol is not in the symbol set, it indicates that the target symbol is an undefined symbol. The terminal device adds the target symbol to the symbol set, creates a user note set corresponding to the target symbol, and then adds the user note to the user note set corresponding to the target symbol. This is equivalent to completing user note classification, so that during subsequent coordinating and use of notes, the user may invoke a same type of user notes by searching for a symbol, thereby helping to further improve user experience.

In a possible implementation, the first detection area may be presented as a first color block, where the first color block is used to cover the text area marked by the first drawn line. Certainly, the first detection area may be presented in another manner. For example, the first detection area may be presented as a first detection box, where the first detection box encloses the text area marked by the first drawn line. For another example, the first detection area may be presented as a first bracket, where a text area in the first bracket is the text area marked by the first drawn line. Correspondingly, the second detection area may be presented as a second color block, a second detection box, a second bracket, or the like.

In a possible implementation, if the terminal device does not receive any instruction that is entered by the user to specify a format of the user note, when generating the user note, the terminal device may make, by default, the format of the user note become the same as formats of texts in the text areas of the detection areas. For example, the two are consistent with each other in terms of a text size, a text color, text locking information, and the like, to meet different requirements of the user.

In a possible implementation, if the terminal device receives an instruction that is entered by the user to specify a format of the user note, when generating the user note, the terminal device may make the format of the user note become the same as a format indicated in the instruction. The format of the user note includes at least one of the following: a font of the user note, a color of the user note, a thickness of the user note, a location of the user note, and a paragraph identifier of the user note. For example, it is assumed that a text font of content presented on the user interaction interface displayed by the terminal device is a standard style of handwriting, and a text color is black, but the user wants to set the font of the user note to Song, and set the color of the user note to blue. The user may enter an instruction on the user interaction interface before drawing a line on the user interaction interface. Then, after the terminal device obtains the instruction, during user note generation by using a text marked by the user with the drawn line, the font of the user note to be ultimately generated may be set to Song, and the color of the user note may be set to blue or the like.

Further, a manner of entering the instruction for specifying the format of the user note may be: drawing, by the user, a user-defined pattern on the user interaction interface, where the pattern can be identified by the terminal device so that the terminal device determines the user-specified format of the user note.

In a possible implementation, the first image frame originates from media information. For example, the media information may be a video stream recorded by the user, and the first image frame may be an image frame in the video stream. For another example, the media information may be an audio stream recorded by the user. After text identification is performed on the audio stream, a corresponding text may be obtained and presented on the user interaction interface, and the text presented on the user interaction interface may be used as the first image frame. For another example, the media information may be a picture shot by the user from a web page (or a document, a text drawn by the user, or the like). After obtaining the picture, the terminal device may use the picture as the first image frame.

According to a second aspect of embodiments of this application, a note generating apparatus is provided. The apparatus includes: an obtaining module, configured to obtain a target text area in a first image frame, where the target text area is a text area (a to-be-identified text area) being read by a user; a conversion module, configured to convert a first drawn line in the target text area into a first detection area, where the first detection area is used to identify a text area marked by the first drawn line; and an identification module, configured to identify a text area in the first detection area to obtain a user note.

It can be learned from the foregoing apparatus that, after obtaining a text area that is in a first image frame and that is being read by a user, that is, after obtaining a target text area in the first image frame, a terminal device may identify a first drawn line entered by the user in the target text area, and convert the first drawn line in the target text area into a first detection area. Then the terminal device may perform OCR on a text area in the first detection area, to obtain a user note. In the foregoing process, the terminal device may intelligently convert the user-input first drawn line into the first detection area that identifies a text area marked by the first drawn line, to perform OCR on this part of text area in a targeted manner, to generate a note required by the user. It can be learned that, in this note generating manner, the user only needs to complete a line drawing operation, with a very small quantity of operations to be performed, and the user does not need to spend too much time, thereby improving user experience.

In a possible implementation, the conversion module is configured to: create a plurality of first rectangles that overlap with the first drawn line in the target text area, where the plurality of first rectangles are sequentially stacked; create a second drawn line in a first rectangle with a largest overlapping degree, where the second drawn line is parallel to a long side of the first rectangle with the largest overlapping degree; and create a second rectangle based on the second drawn line, where the second rectangle is used as the first detection area, the second drawn line is located in the second rectangle, the second drawn line is parallel to a long side of the second rectangle, and a length of a short side of the second rectangle is greater than a row height of the target text area.

In a possible implementation, the apparatus further includes an optimization module, configured to: divide the second rectangle into a plurality of sub-rectangles; and remove, from the plurality of sub-rectangles, a sub-rectangle whose pixel proportion is less than a preset first threshold, and use a third rectangle formed by remaining sub-rectangles as the first detection area.

In a possible implementation, the obtaining module is configured to: if state information about text areas in the first image frame is different from state information about text areas in a second image frame, determine the target text area in the first image frame based on the state information about the text areas in the first image frame, where the second image frame is an image frame previous to the first image frame.

In a possible implementation, the state information about the text areas includes at least one of the following: a quantity of the text areas, sizes of the text areas, angles of the text areas, and locations of the text areas.

In a possible implementation, the obtaining module is configured to: if there is a human body area of a user in the first image frame, compare a quantity of text areas in the first image frame with a quantity of text areas in the second image frame, to detect whether a new text area exists in the first image frame; and if a new text area exists in the first image frame, determine the new text area as the target text area; or if there is no new text area in the first image frame, determine a text area associated with the human body area as the target text area; or if there is no human body area of a user in the first image frame, determine a text area with a largest semantic size as the target text area, where a semantic size of a text area is a ratio of a size of the text area to a semantic distance of the text area, and the semantic distance of the text area is a distance between the text area and a central point of the first image frame.

In a possible implementation, a second detection area further exists in the target text area, the second detection area is obtained by converting a third drawn line in a third image frame, the third image frame is previous to the first image frame, and a plurality of image frames exist between the third image frame and the first image frame; and the identification module is configured to: if a distance between a text area in the first detection area and a text area in the second detection area is greater than or equal to a preset second threshold, respectively identify the text area in the first detection area and the text area in the second detection area to obtain two user notes; or if a distance between the text area in the first detection area and a text area in the second detection area is less than a preset second threshold, merge the first detection area and the second detection area into a third detection area, and identify a text area in the third detection area to obtain the user note.

In a possible implementation, the apparatus further includes a merging module, configured to merge the two user notes to obtain a new user note; the two user notes are located in a same paragraph; and the new user note includes other texts other than the two user notes in the paragraph and the two user notes that are highlighted.

In a possible implementation, the apparatus further includes a correction module, configured to correct the text area in the first detection area to obtain a corrected text area; and the identification module is configured to identify the corrected text area to obtain the user note.

In a possible implementation, a target symbol exists in the target text area, and the apparatus further includes a classification module, configured to: if the target symbol is included in a preset symbol set, add the user note to a user note set corresponding to the target symbol; or if the target symbol is not included in the symbol set, add the target symbol to the symbol set, create a user note set corresponding to the target symbol, and then add the user note to the user note set corresponding to the target symbol.

In a possible implementation, the first detection area may be presented as a first color block, where the first color block is used to cover the text area marked by the first drawn line. Certainly, the first detection area may be presented in another manner. For example, the first detection area may be presented as a first detection box, where the first detection box encloses the text area marked by the first drawn line. For another example, the first detection area may be presented as a first bracket, where a text area in the first bracket is the text area marked by the first drawn line. Correspondingly, the second detection area may be presented as a second color block, a second detection box, a second bracket, or the like.

In a possible implementation, a format of the user note is the same as formats of texts in the text areas of the detection areas.

In a possible implementation, a format of the user note is determined based on an instruction entered by the user, and the format of the user note includes at least one of the following: a font of the user note, a color of the user note, a thickness of the user note, a location of the user note, and a paragraph identifier of the user note.

In a possible implementation, the first image frame originates from media information.

According to a third aspect of embodiments of this application, a note generating apparatus is provided. The apparatus includes a memory and a processor. The memory stores code, the processor is configured to execute the code, and when the code is executed, the note generating apparatus performs the method according to any one of the first aspect or the possible implementations of the first aspect.

According to a fourth aspect of embodiments of this application, a computer storage medium is provided. The computer storage medium stores one or more instructions. When the one or more instructions are executed by one or more computers, the one or more computers are enabled to perform the method according to any one of the first aspect or the possible implementations of the first aspect.

According to a fifth aspect of embodiments of this application, a computer program product is provided. The computer program product stores instructions, and when the instructions are executed by a computer, the computer is enabled to perform the method according to any one of the first aspect or the possible implementations of the first aspect.

In embodiments of this application, after obtaining a text area that is in a first image frame and that is being read by a user, that is, after obtaining a target text area in the first image frame, a terminal device may identify a first drawn line entered by the user in the target text area, and convert the first drawn line in the target text area into a first detection area. Then the terminal device may perform OCR on a text area in the first detection area, to obtain a user note. In the foregoing process, the terminal device may intelligently convert the user-input first drawn line into the first detection area that identifies a text area marked by the first drawn line, to perform OCR on this part of text area in a targeted manner, to generate a note required by the user. It can be learned that, in this note generating manner, the user only needs to complete a line drawing operation, with a very small quantity of operations to be performed, and the user does not need to spend too much time, thereby improving user experience.

### BRIEF DESCRIPTION OF DRAWINGS

FIG. 1 is a schematic diagram of a structure of a note generating system according to an embodiment of this application;

FIG. 2 is a schematic diagram of a user reading scenario according to an embodiment of this application;

FIG. 3 is another schematic diagram of a structure of a note generating system according to an embodiment of this application;

FIG. 4 is a schematic flowchart of a note generating method according to an embodiment of this application;

FIG. 5 is a schematic diagram of a first drawn line according to an embodiment of this application;

FIG. 6 is a schematic diagram of a first detection area according to an embodiment of this application;

FIG. 7 is a schematic diagram of a first rectangle according to an embodiment of this application;

FIG. 8 is a schematic diagram of a second drawn line according to an embodiment of this application;

FIG. 9 is a schematic diagram of a second rectangle according to an embodiment of this application;

FIG. 10 is a schematic diagram of a third rectangle according to an embodiment of this application;

FIG. 11 is a schematic diagram of a user note according to an embodiment of this application;

FIG. 12 is a schematic diagram of symbols according to an embodiment of this application;

FIG. 13 is another schematic flowchart of a note generating method according to an embodiment of this application;

FIG. 14 is a schematic diagram of a third drawn line according to an embodiment of this application;

FIG. 15 is another schematic diagram of a first drawn line according to an embodiment of this application;

FIG. 16 is a schematic diagram of a third detection area according to an embodiment of this application;

FIG. 17 is another schematic diagram of a user note according to an embodiment of this application;

FIG. 18 is a schematic diagram of note merging according to an embodiment of this application;

FIG. 19 is another schematic diagram of note merging according to an embodiment of this application;

FIG. 20 is still another schematic diagram of note merging according to an embodiment of this application;

FIG. 21 is a schematic diagram of a structure of a note generating apparatus according to an embodiment of this application; and

FIG. 22 is another schematic diagram of a structure of a note generating apparatus according to an embodiment of this application.

### DESCRIPTION OF EMBODIMENTS

Embodiments of this application provide a note generating method and related devices for the note generating method, which provide a new note generating manner. A user only needs to complete a line drawing operation, with a very small quantity of operations to be performed, and the user does not need to spend too much time, thereby improving user experience.

In the specification, claims, and accompanying drawings of this application, the terms “first”, “second”, and the like are intended to distinguish between similar objects but do not necessarily indicate a specific order or sequence. It needs to be understood that, the terms used in such a way are interchangeable in proper circumstances, and this is merely a discrimination manner for describing objects having a same attribute in embodiments of this application. In addition, the terms “include”, “contain” and any other variants mean to cover non-exclusive inclusion, so that a process, method, system, product, or device that includes a series of units is not necessarily limited to those units, but may include other units not expressly listed or other units inherent to such a process, method, system, product, or device.

The OCR technology is an important technology in the image processing field, and can identify a text area in an image, to extract text information.

In a user reading scenario, it is assumed that a user is reading a book, the user is interested in a part of content in the book, and the user needs to record a corresponding note (that is, the part of content the user is interested in) on a terminal device. In this case, the user may photograph the book by using the terminal device to obtain a video stream. Then the terminal device may perform OCR on an image frame in the video stream, to extract a text in the image frame as a user note.

To accurately capture the content that the user needs to record, the user needs to manually adjust a camera of the terminal device, so that the camera is exactly aligned with the content that the user needs to record, that is, a field of view of the camera just presents that part of content. In this case, content presented in a text area of a captured image frame is the content that the user needs to record. After identifying the image, the terminal device may extract that part of content as the user-required note. However, in this note generating manner, the user needs to perform plenty of manual operations and usually spends much time, resulting in poor user experience.

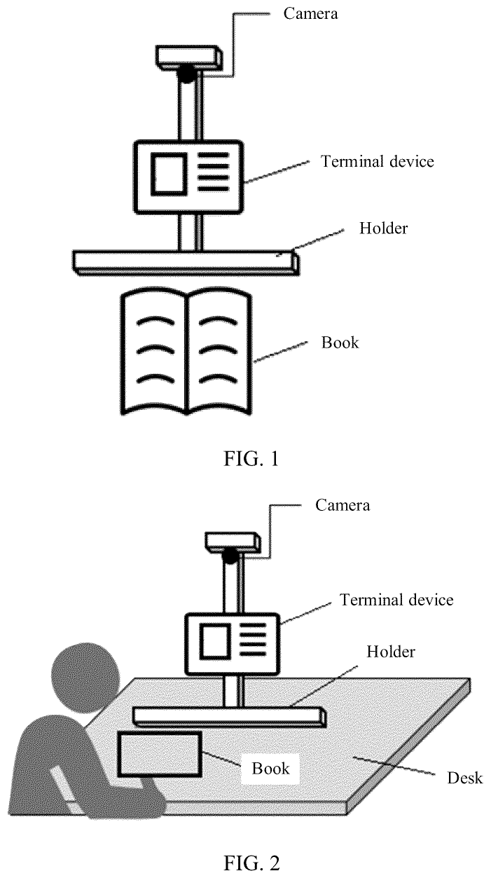

To resolve the foregoing problem, an embodiment of this application provides a note generating method. The method may be applied to a note generating system shown in FIG. 1 (FIG. 1 is a schematic diagram of a structure of a note generating system according to an embodiment of this application). The note generating system includes a camera, a terminal device, and a holder. The holder is usually standing on a desk of a user, and may be configured to fix the camera, or may be configured to place the terminal device. A pick-up head of the camera is configured to photograph a book on the desk, to generate a video stream, and send the video stream to the terminal device. The terminal device has a user interaction interface, plays a video stream on the user interaction interface, generates a user note based on a user operation, and displays the user note on the user interaction interface for the user to watch and use. For example, it is assumed that the user does not perform a line drawing operation on a physical book. In this case, a video stream generated through shooting by the camera does not have any line drawn by the user. When the terminal device plays, on the user interaction interface, a video stream from the camera, the user may read content presented by the video stream, and directly draw, on the user interaction interface, a line for a text that the user is interested in. When the user's line drawing operation is completed (for example, the user's line drawing operation pauses), the terminal device may capture, from an original video stream, an image frame at this time, synthesize the image frame into a new image frame that includes the line drawn by the user, and then perform a series of processing on the new image frame, to generate a user note (that is, the text that the user is interested in). For another example, as shown in FIG. 2 (FIG. 2 is a schematic diagram of a user reading scenario according to an embodiment of this application), it is assumed that the user has performed, on a physical book, a line drawing operation on a text that the user is interested in. Then a video stream generated through shooting by the camera includes not only a text of the book, but also a line drawn by the user. Therefore, the terminal device may capture, from the video stream from the camera, an image frame when the line drawing operation of the user is completed, and then perform a series of processing on the image frame, to generate a user note.

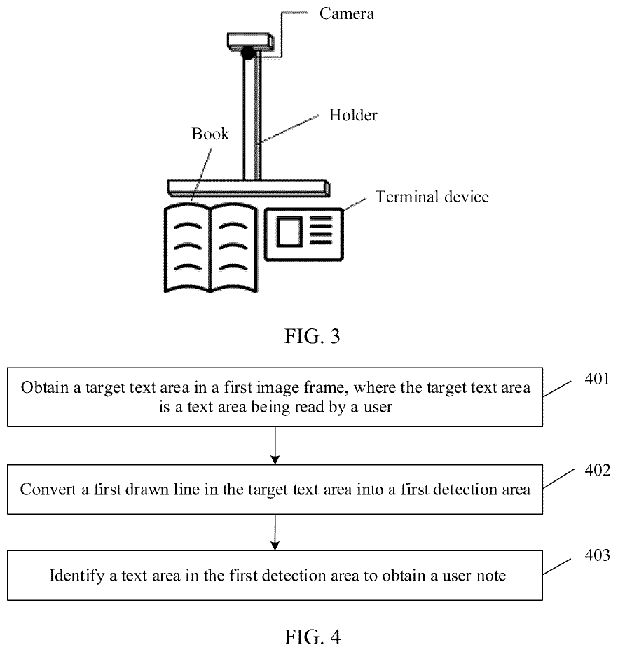

It needs to be understood that, in the foregoing embodiments, description is made by merely using examples in which the terminal device is placed on the holder. In actual application, the terminal device may not be placed on the holder. For example, as shown in FIG. 3 (FIG. 3 is another schematic diagram of a structure of a note generating system according to an embodiment of this application), the terminal device may be placed on a desk, or the like.

It needs to be further understood that, in the foregoing embodiments, description is made by merely using examples in which the camera and the terminal device are two mutual devices. In actual application, the camera and the terminal device may be a same device. For example, the user may directly photograph a book by using a camera provided by the terminal device.

It needs to be further understood that, in the foregoing embodiments, description is made by merely using examples in which a moment at which a user note is generated is a time when a line drawing operation of the user is completed, and this does not constitute a limitation on a moment at which a user note is generated in this application. For example, a moment at which a user note is generated may be real-time, that is, when the user is drawing a line, the terminal device captures an image frame in real time, processes the image frame, and generates a corresponding user note till the user's drawing operation ends.

For a further understanding of a process of generating a user note, the process is further described below. For ease of description, the following description uses an example in which a moment at which a user note is generated is a moment at which a drawing operation of the user is completed. In a video stream, the user may complete at least one line drawing operation. In the following description, an image frame corresponding to a moment at which a current line drawing operation is completed in a video stream is referred to as a first image frame, and a line left in the first image frame during the current line drawing operation of the user is referred to as a first drawn line.

It needs to be noted that there are two cases of generating a user note. In the following description, a first case is described first. FIG. 4 is a schematic flowchart of a note generating method according to an embodiment of this application. The method may be applied to the note generating system shown in FIG. 1 or FIG. 3. As shown in FIG. 4, the method includes the following steps.

401: Obtain a target text area in a first image frame, where the target text area is a text area being read by a user.

In this embodiment, the first image frame obtained by the terminal device from a video stream may include a plurality of text areas and other non-text areas. For example, content presented by the first image frame may include a plurality of books on a desk, a hand of a user, a head of the user, and the like. In the plurality of books, for a book that is opened, there may be a plurality of cases for the book: (1) two pages that are spread out of the book each include a text, and then two areas occupied by the two pages in the first image frame may be understood as two text areas; or (2) among the two pages that are spread out of the book, only one page includes a text, and then two areas occupied by the two pages in the first image frame may be understood as a text area and a non-text area; or (3) neither of the two pages that are spread out of the book includes a text, and then two areas occupied by the two pages in the first image frame may be understood as two non-text areas, and the like. In addition, an area occupied by a human body part such as a hand or a head of the user in the first image frame may be understood as a human body area of the user, and is also a non-text area.

Because the first image frame includes a plurality of text areas, the terminal device may determine, from the plurality of text areas in the first image frame, a text area (which may also be understood as a to-be-identified text area) being read by the user, that is, a target text area. Specifically, the terminal device may determine the target text area in the following manners.

(1) The terminal device may obtain a second image frame from the video stream, where the second image frame is usually an image frame previous to the first image frame (that is, the second image frame is a first image frame previous to the first image frame). In this case, the terminal device may analyze the first image frame and the second image frame, to obtain state information about text areas in the first image frame and state information about text areas in the second image frame. The state information about the text areas in the first image frame includes at least one of the following: a quantity of the text areas in the first image frame, sizes of the text areas in the first image frame, angles of the text areas in the first image frame, locations of the text areas in the first image frame, and the like. The state information about the text areas in the second image frame includes at least one of the following: a quantity of the text areas in the second image frame, sizes of the text areas in the second image frame, angles of the text areas in the second image frame, locations of the text areas in the second image frame, and the like. It needs to be noted that, for any text area in the first image frame, an angle of the text area is an angle presented by the text area in a first image coordinate system, and a location of the text area is a location of the text area in the first image coordinate system. The first image coordinate system is constructed based on the first image frame (for example, a vertex in an upper left corner of the first image frame is used as an origin of the entire first image coordinate system). Similarly, for any text area in the second image frame, for an angle of the text area and a location of the text area, refer to the foregoing description. Details are not described herein again.

(2) After obtaining the state information about the text areas in the first image frame and the state information about the text areas in the second image frame, the terminal device may detect whether there is a difference between the state information about the text areas in the first image frame and the state information about the text areas in the second image frame.

(3) If there is a difference between the state information about the text areas in the first image frame and the state information about the text areas in the second image frame, it indicates that, compared with the second image frame, at least one of the plurality of text areas in the first image frame has changed. Therefore, the terminal device may perform further analysis based on the state information about the text areas in the first image frame, to determine the target text area in the plurality of text areas in the first image frame; where
specifically, the terminal device may perform multi-layer analysis based on the state information about the text areas in the first image frame, to determine the target text area in the first image frame, and a process is as follows:
(3.1) the terminal device detects whether there is a human body area (for example, a hand area of the user) of the user in the first image frame;
(3.2) if there is a human body area of the user in the first image frame, it indicates that a part of the human body of the user is on the desk. In this case, whether the part of the human body of the user has opened a new book between a current moment and a previous moment may be further analyzed. Therefore, the terminal device may compare whether a quantity of text areas in the first image frame is the same as a quantity of text areas in the second image frame, to detect whether a new text area exists in the first image frame; and
(3.3) if the quantity of text areas in the first image frame is different from the quantity of text areas in the second image frame, that is, compared with the second image frame, a new text area exists in the first image frame, it indicates that the user has opened a new book on the table, and, very probably, the user is reading the new book. In this case, an area occupied by a page of the new book in the first image frame is the new text area. Therefore, the terminal device may directly determine the new text area as the target text area; or
(3.4) if the quantity of text areas in the first image frame is the same as the quantity of text areas in the second image frame, that is, compared with the second image frame, there is no new text area in the first image frame, it indicates that the user does not open any new book on the desk. In this case, a book associated with the part of the human body of the user may be regarded as a book being read by the user among a plurality of books on the desk. Therefore, the terminal device determines a text area associated with the human body area as the target text area. For example, the terminal device may determine a text area that overlaps with a hand area of the user as the target text area. For another example, the terminal device may determine a text area facing a head area of the user as the target text area; or
(3.5) if there is no human body area of the user in the first image frame, it indicates that no any part of the human body of the user is on the desk. Therefore, static analysis may be directly performed on the plurality of books on the desk, to determine which book is being read by the user. In other words, the terminal device may determine, in the plurality of text areas in the first image frame, a text area with a largest semantic size as the target text area. For any text area, a semantic size of the text area is a ratio of a size of the text area to a semantic distance of the text area, where the semantic distance of the text area is a distance between the text area and a central point of the first image frame.

(4) If there is no difference between the state information about the text areas in the first image frame and the state information about the text areas in the second image frame, it indicates that, compared with the second image frame, no text area in the plurality of text areas in the first image frame has changed. In this case, the terminal device directly determines a text area that is being read by the user and that is determined in the second image frame as the target text area in the first image frame, that is, the text area being read by the user in the first image frame.

402: Convert a first drawn line in the target text area into a first detection area.

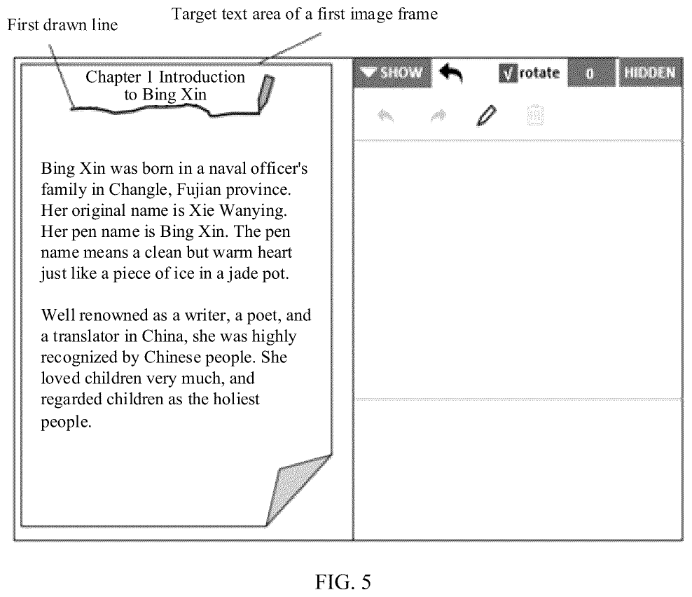

After the target text area is determined, the terminal device may identify a first drawn line (which may also be referred to as a user-drawn line) in the target text area. The first drawn line may be presented in a plurality of forms: the first drawn line may be a straight line, or the first drawn line may be a wavy line, or the first drawn line may be an irregular curve, or the like. This is not limited herein. Further, relative to a text area marked by the first drawn line, there may be a plurality of location relationships between the first drawn line and a text in the text area: the first drawn line may cross the text (that is, intersect with the text), or the first drawn line may be located at the bottom of the text (which may also be understood as an underscore), or the like. For example, as shown in FIG. 5 (FIG. 5 is a schematic diagram of a first drawn line according to an embodiment of this application), in the target text area, a first drawn line entered by the user is a wavy line, and a text area marked by the first drawn line is an area in which “Chapter 1 Introduction to Bing Xin” is located. It can be learned that, a part of the first drawn line intersects with a part of the text “Chapter 1 Introduction to Bing Xin”, and the other part is located below the other part of the text “Chapter 1 Introduction to Bing Xin”.

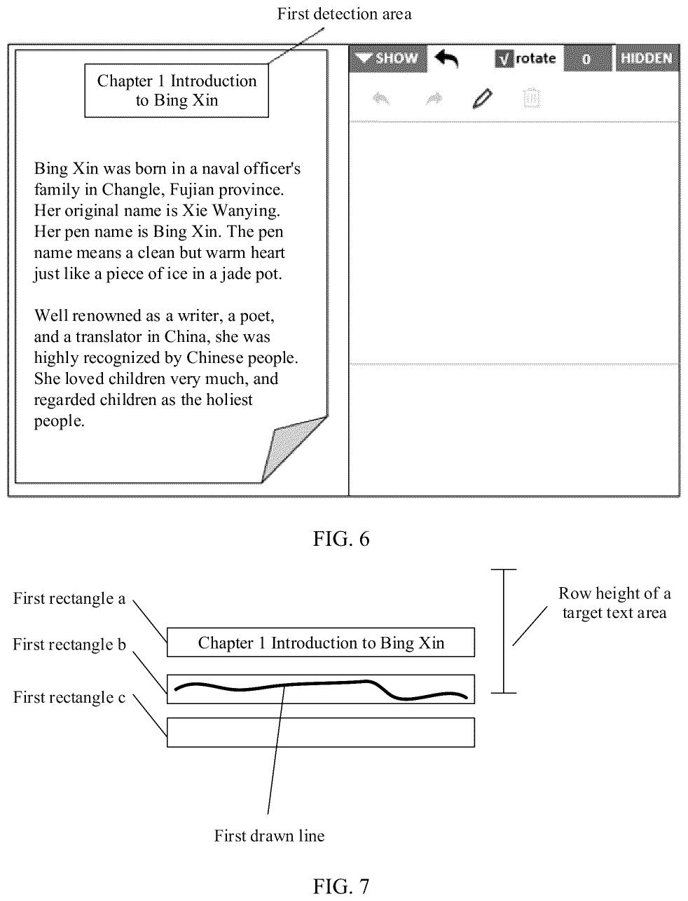

After identifying the first drawn line, the terminal device may convert the first drawn line into a first detection area. The first detection area is usually a rectangle, and identifies a text area marked by the first drawn line. It needs to be noted that the first detection area may be presented in a plurality of manners: (1) the first detection area may be presented as a first color block, where the first color block covers the text area marked by the first drawn line; or (2) the first detection area may be presented as a first detection box, where the first detection box encloses the text area marked by the first drawn line; or (3) the first detection area may be presented as a first bracket, where a text area in the first bracket is the text area marked by the first drawn line; or the like. For example, as shown in FIG. 6 (FIG. 6 is a schematic diagram of a first detection area according to an embodiment of this application, and FIG. 6 is obtained by drawing based on FIG. 5. It needs to be noted that in FIG. 6, description is made by using an example in which the first detection area is a first color block, but this does not constitute a limitation on a presentation manner of the first detection area in this application), the terminal device may convert the first drawn line into a first detection area in a rectangular state, and display the first detection area on the user interaction interface, where a text area enclosed (identified) by the first detection area is an area in which “Chapter 1 Introduction to Bing Xin” is located. Specifically, the terminal device may obtain the first detection area in the following manner.

(1) The terminal device first creates a plurality of first rectangles that overlap with the first drawn line in the target text area, where the plurality of first rectangles are sequentially stacked. For any first rectangle, there is a degree of overlapping between the first rectangle and the first drawn line, and the overlapping degree indicates a size of a part that is of the first drawn line and that is in the first rectangle. It needs to be noted that, sizes of the plurality of first rectangles are the same, and a length of a short side of each first rectangle is related to a row height of the target text area. The row height of the target text area is an average height of a plurality of rows of texts in the target text area. The row height of the target text area may be obtained by the terminal device by estimating the target text area based on some image morphology algorithms. For example, as shown in FIG. 7 (FIG. 7 is a schematic diagram of a first rectangle according to an embodiment of this application, and FIG. 7 is obtained by drawing based on FIG. 5), the terminal device may create, near the first drawn line, a plurality of first rectangles that are sequentially stacked: a first rectangle a, a first rectangle b, and a first rectangle c, where lengths of long sides of the three first rectangles are equal to one another, lengths of short sides of the three first rectangles are equal to one another, and all the lengths of the short sides of the three first rectangles are one fourth of the row height of the target text area, a degree of overlapping between the first rectangle a and the first drawn line is 0, a degree of overlapping between the first rectangle b and the first drawn line is 100%, and a degree of overlapping between the first rectangle c and the first drawn line is 0. It can be learned that, the entire first drawn line is located in the first rectangle b, and no part of the first drawn line is located in the first rectangle a or the first rectangle c.

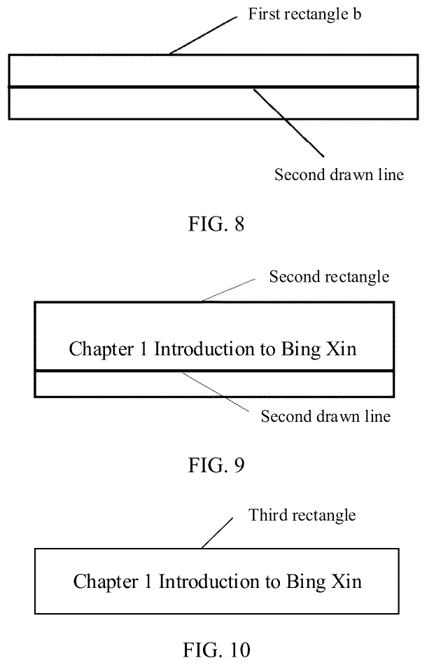

(2) Then the terminal device selects, from the plurality of first rectangles, a first rectangle with a largest overlapping degree, and creates a second drawn line in the first rectangle with the largest overlapping degree. It needs to be noted that, the second drawn line is usually a straight line, the second drawn line may be located at a central point (or around the central point) of the first rectangle with the largest overlapping degree, and the second drawn line is parallel to a long side of the first rectangle with the largest overlapping degree. As shown in FIG. 8 (FIG. 8 is a schematic diagram of a second drawn line according to an embodiment of this application, and FIG. 8 is drawn based on FIG. 7), after determining that the degree of overlapping between the first rectangle b and the first drawn line is the largest, the terminal device may construct a second drawn line at a central location of the first rectangle b, where a distance between the second drawn line and an upper long side of the first rectangle b is one eighth of the row height of the target text area, and a distance between the second drawn line and a lower long side of the first rectangle b is one eighth of the row height of the target text area.

(3) Finally, the terminal device creates a second rectangle based on the second drawn line, where the second rectangle may serve as the first detection area used to implement OCR. It needs to be noted that, the entire second drawn line is located in the second rectangle, the second drawn line is located slightly below a central point of the second rectangle, the second drawn line is parallel to a long side of the second rectangle, and a length of a short side of the second rectangle is greater than the row height of the target text area. For example, as shown in FIG. 9 (FIG. 9 is a schematic diagram of a second rectangle according to an embodiment of this application, and FIG. 9 is drawn based on FIG. 8), the terminal device creates a second rectangle based on the second drawn line, the second drawn line is located in the second rectangle, and a distance between the second drawn line and an upper long side of the second rectangle is two third the row height of the target text area.

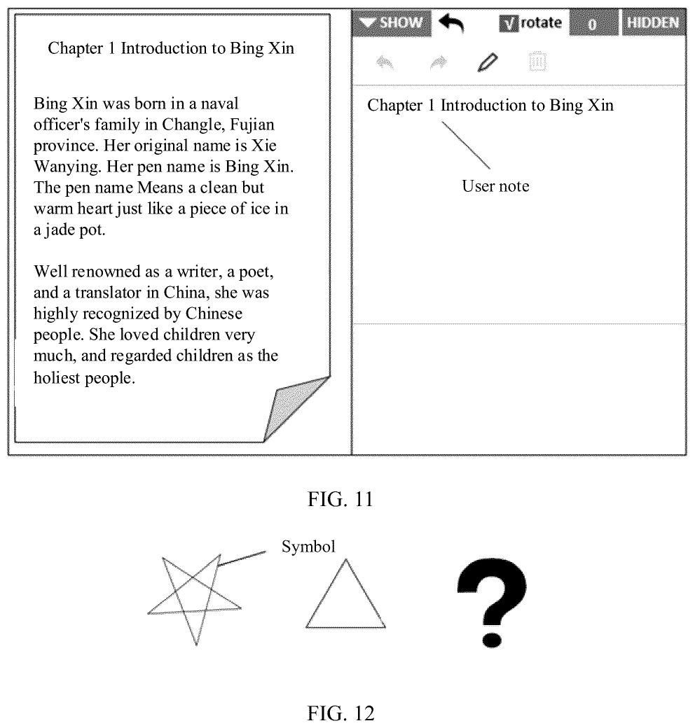

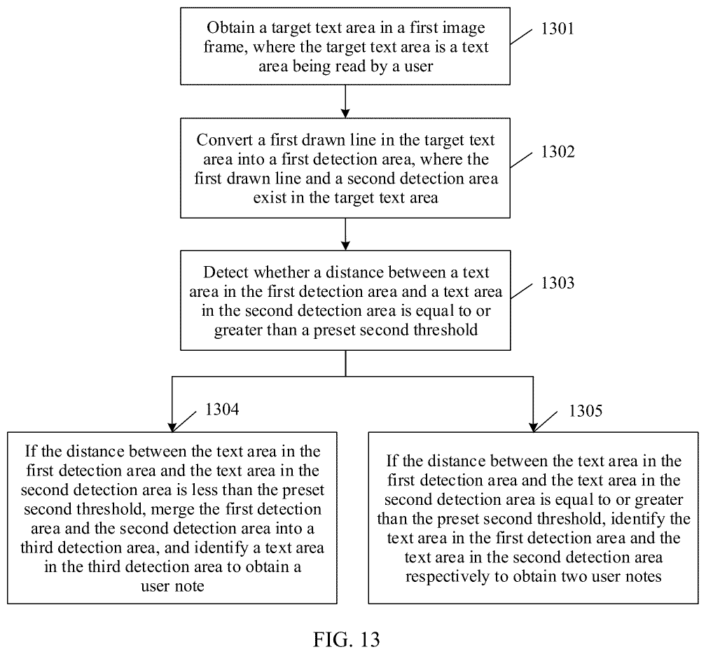

Further, after obtaining the second rectangle, the terminal device may further optimize the second rectangle, to remove some unnecessary parts from the second rectangle, and keep a valid part. Specifically, the terminal device may optimize the second rectangle in the following manners:
(1) the terminal device divides the second rectangle into a plurality of sub-rectangles, where an area enclosed by each sub-rectangle as a row of pixels in a text area enclosed by the second rectangle. In this case, in the plurality of sub-rectangles, areas enclosed by some sub-rectangles are blank rows (that is, values of almost all pixels in the row of pixels are the same), and areas enclosed by the rest sub-rectangles are valid rows (that is, pixels in the row include two parts of pixels, and values of the two parts of pixels are obviously different); and
(2) after obtaining the plurality of sub-rectangles, for any sub-rectangle, the terminal device may perform computing based on all pixels in the sub-rectangle, to obtain a pixel proportion of the sub-rectangle. In this way, pixel proportions of all sub-rectangles may be obtained. The terminal device divides all the sub-rectangles into two parts by presetting a first threshold (which may also be understood as a preset pixel proportion threshold, a value of the threshold may be set based on an actual requirement, and this is not limited herein). Pixel proportions of a first part of the sub-rectangles are less than the preset first threshold, and pixel proportions of a second part of the sub-rectangles are greater than or equal to the preset first threshold. Then the terminal device may remove the first part of the sub-rectangles, and use the second part of the sub-rectangles to form a third rectangle, which is to be used as the first detection area to finally implement OCR. For example, as shown in FIG. 10, (FIG. 10 is a schematic diagram of a third rectangle according to an embodiment of this application, and FIG. 10 is drawn based on FIG. 9), after the second rectangle is optimized, a third rectangle may be obtained. Compared with the second rectangle, the third rectangle eliminates an unnecessary part, so that a size is reduced, thereby effectively reducing an amount of computing required for subsequent OCR.

403: Identify a text area in the first detection area to obtain a user note.

After obtaining the first detection area, the terminal device may remind the user whether to perform text identification. If the user enters a text identification instruction, the terminal device may perform OCR on the text area in the first detection area based on the instruction, that is, extract, as a user note, a text presented in the text area enclosed by the first detection area. For example, as shown in FIG. 11 (FIG. 11 is a schematic diagram of a user note according to an embodiment of this application, and FIG. 11 is drawn based on FIG. 6), after performing OCR on the text area enclosed by the first detection area, the terminal device may extract a text “Chapter 1 Introduction to Bing Xin”, and display the text as a user note on the user interaction interface for the user to use and view.

Further, to improve OCR speed, the terminal device may adjust the text area in the first detection area. A manner of adjusting the text area by the terminal device is as follows: the terminal device may correct the text area in the first detection area to obtain a corrected text area. For example, if an angle of the text area in the first detection area is not zero degrees, it indicates that the text area in the first detection area is skewed rather than facing the camera. In this case, the terminal device may adjust the angle of the text area in the first detection area till the angle is zero degrees, to obtain a corrected text area. Then the terminal device performs OCR on the corrected text area to obtain a user note.

Further, in the first image frame, probably there is not only the first drawn line entered by the user but also a target symbol entered by the user in the target text area, the target symbol is usually located near the text area marked by the first drawn line, and the target symbol corresponds to a type of user notes, that is, a user note set. For example, as shown in FIG. 12 (FIG. 12 is a schematic diagram of symbols provided in an embodiment of this application), if the target symbol is a question mark, the target symbol is used to represent a type of user notes about which the user doubts; or if the target symbol is an asterisk, the target symbol is used to indicate a type of user notes that are highlighted by the user, or the like. In this case, after the text area in the first detection area is identified to obtain the user note, the terminal device may first detect whether the target symbol is in a preset symbol set (where the symbol set is usually preset in a database of the terminal device). If the target symbol is in the symbol set, it indicates that the target symbol is a defined (existing) symbol, and the terminal device adds the user note to a user note set corresponding to the target symbol. If the target symbol is not in the symbol set, it indicates that the target symbol is an undefined (not existing) symbol, and the terminal device adds the target symbol to the symbol set, creates a user note set corresponding to the target symbol, and then adds the user note to the user note set corresponding to the target symbol. This is equivalent to completing user note classification, so that during subsequent coordinating and use of notes, the user may invoke a same type of user notes by searching for a symbol, thereby helping to further improve user experience.

Still further, if the terminal device does not receive any instruction that is entered by the user to specify a format of the user note, when generating the user note, the terminal device may make, by default, the format of the user note become the same as formats of texts in the text areas of the detection areas. For example, the two are consistent with each other in terms of a text size, a text color, text locking information, and the like.

Further, if the terminal device receives an instruction that is entered by the user to specify a format of the user note, when generating the user note, the terminal device may make the format of the user note become the same as a format indicated in the instruction. The format of the user note includes at least one of the following: a font of the user note, a color of the user note, a thickness of the user note, a location of the user note, and a paragraph identifier of the user note. For example, it is assumed that a text font of content presented on the user interaction interface displayed by the terminal device is a standard style of handwriting, and a text color is black, but the user wants to set the font of the user note to Song, and set the color of the user note to blue. The user may enter an instruction on the user interaction interface before drawing a line on the user interaction interface. Then, after the terminal device obtains the instruction, during user note generation by using a text marked by the user with the drawn line, the font of the user note to be ultimately generated may be set to Song, and the color of the user note may be set to blue or the like.

It needs to be noted that, a manner of entering the instruction for specifying the format of the user note may be: drawing, by the user, a user-defined pattern on the user interaction interface, where the pattern can be identified by the terminal device so that the terminal device determines the user-specified format of the user note.

In embodiments of this application, after obtaining a text area that is in a first image frame and that is being read by a user, that is, after obtaining a target text area in the first image frame, a terminal device may identify a first drawn line entered by the user in the target text area, and convert the first drawn line in the target text area into a first detection area. Then the terminal device may perform OCR on a text area in the first detection area, to obtain a user note. In the foregoing process, the terminal device may intelligently convert the user-input first drawn line into the first detection area that identifies a text area marked by the first drawn line, to perform OCR on this part of text area in a targeted manner, to generate a note required by the user. It can be learned that, in this note generating manner, the user only needs to complete a line drawing operation, with a very small quantity of operations to be performed, and the user does not need to spend too much time, thereby improving user experience.

Further, the terminal device may determine a user intention in real time, that is, track and correct in real time, in the first image frame, a text area being read by the user. In this way, the terminal device does not need to process all text areas in the first image frame, thereby improving precision and speed of information extraction.

Further, the terminal device may further determine, with reference to information about previous and next image frames in the video stream, that is, the state information about the text areas in the first image frame and the state information about the text areas in the second image frame, whether a text area has changed, that is, whether a book has been moved or opened, or whether a page has been turned over, to avoid correction in an operation process of the user on the book, thereby improving determining precision.

Further, the terminal device may estimate an average row height in the target text area, determine a size of a detection area based on a flat row height, and further obtain a detection area of a precise size based on processing of a blank row and a valid row. It can be seen that, for text areas with different row heights, the terminal device may accurately catch and identify these areas, to generate the user note.

Further, the terminal device identifies a target symbol; determines, based on the target symbol and a database, whether the target symbol is a new symbol; and determines, with reference to a drawn line, whether to classify user notes. This helps the user sort out various notes for subsequent use.

Furthermore, corresponding attributes, including a text color, a text thickness, a text size, and typesetting of an original text, may be assigned to a corresponding user note, so that the user note can meet a requirement of the user.

The foregoing description is about the first case. A second case is described below. FIG. 13 is another schematic flowchart of a note generating method according to an embodiment of this application. The method may be applied to the note generating system shown in FIG. 1 or FIG. 3. As shown in FIG. 13, the method includes the following steps.

1301: Obtain a target text area in a first image frame, where the target text area is a text area being read by a user (that is, a to-be-identified text area).

In this embodiment, for description of step 1301, refer to related description of step 401 in the embodiment shown in FIG. 4. Details are not described herein again.

1302: Convert a first drawn line in the target text area into a first detection area, where the first drawn line and a second detection area exist in the target text area.

For description of step 1302, refer to related description of step 402 in the embodiment shown in FIG. 4. Details are not described herein again.

A difference between step 1302 and step 402 lies in that: in step 402, only a first drawn line exists in the target text area, but in step 1302, not only a first drawn line exists in the target text area, but also a second detection area exists in the target text area, where the second detection area is obtained on a basis of converting a third drawn line in a third image frame, the third image frame is previous to the first image frame, and a plurality of image frames exist between the third image frame and the first image frame.

It may be understood that the second detection area may be presented as a second color block, a second detection box, a second bracket, or the like.

It needs to be noted that the third image frame is an image frame corresponding to a moment at which a previous line drawing operation is completed, and a drawn line left in the third image during the previous line drawing operation is referred to as a third drawn line. In this case, the terminal device may convert the third drawn line into a second detection area. After obtaining the second detection area, the terminal device does not receive a text identification instruction from the user, so the terminal device does not perform OCR on a text area in the second detection area, but keeps the second detection area. It can be learned that, when a current line drawing operation is completed, a first drawn line and a second detection area exist in the first image frame obtained by the terminal device.

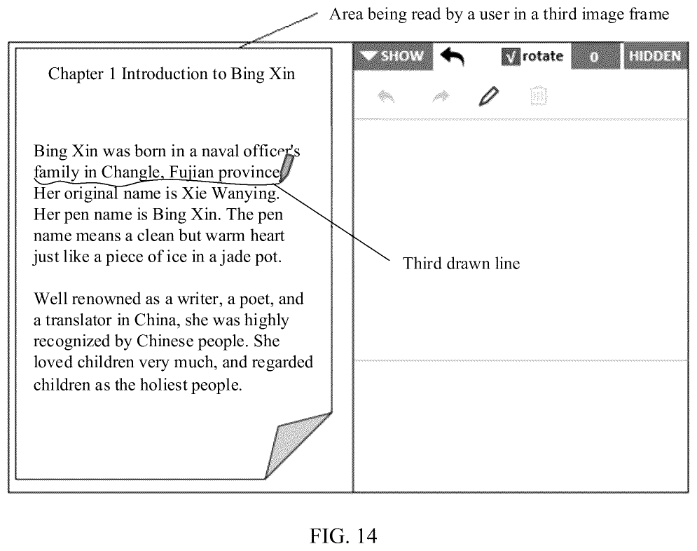

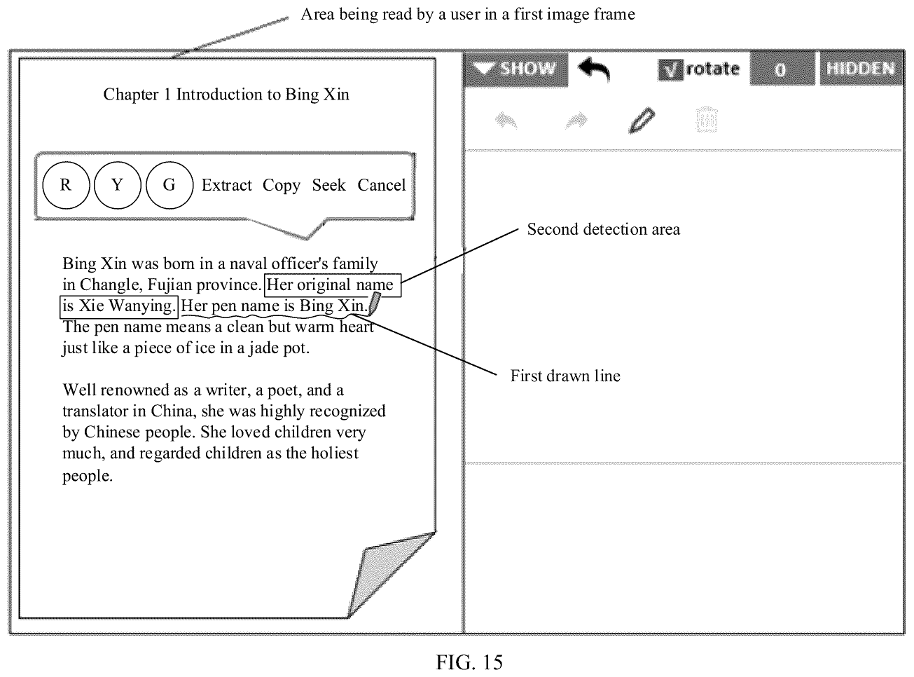

For example, as shown in FIG. 14 (FIG. 14 is a schematic diagram of a third drawn line according to an embodiment of this application), in a text area being read by the user in a third image frame, the user first completes a line drawing operation, that is, first enters a third drawn line. A text area marked by the third drawn line is an area in which “Her original name is Xie Wanying” is located. The terminal device converts the third drawn line into a second detection area, and reminds the user whether to perform text identification. Because the user does not tap “Extract” (that is, no text identification instruction is entered), the terminal device does not perform OCR on a text area in the second detection area, and keeps the second detection area. Then, as shown in FIG. 15 (FIG. 15 is another schematic diagram of a first drawn line according to an embodiment of this application), in a text area being read by the user in a first image frame, the user completes a line drawing operation again, that is, continues to enter a first drawn line. A text area marked by the first drawn line is “Her pen name is Bing Xin”. Similarly, the terminal device may convert the first drawn line into a first detection area.

It needs to be understood that, for a process in which the terminal device obtains the text area being read by the user in the third image frame, refer to the process in which the terminal device obtains the text area being read by the user in the first image frame in the embodiment shown in FIG. 4. Details are not described herein again. Similarly, for a process in which the terminal device generates the second detection area based on the third drawn line, refer to the process in which the terminal device generates the first detection area based on the first drawn line in the embodiment shown in FIG. 4. Details are not described herein again.

1303: Detect whether a distance between a text area in the first detection area and a text area in the second detection area is greater than or equal to a preset second threshold.

After obtaining the first detection area, the terminal device may detect whether the distance between the text area in the first detection area and the text area in the second detection area is greater than or equal to the preset second threshold, to determine whether texts in the two text areas are the same note. A value of the preset second threshold may be set according to an actual requirement. For example, the preset second threshold is a distance of one character or a distance of two characters, and this is not limited herein.

1304: If the distance between the text area in the first detection area and the text area in the second detection area is less than the preset second threshold, merge the first detection area and the second detection area into a third detection area, and identify a text area in the third detection area to obtain a user note.

1305: If the distance between the text area in the first detection area and the text area in the second detection area is greater than or equal to the preset second threshold, identify the text area in the first detection area and the text area in the second detection area respectively to obtain two user notes.

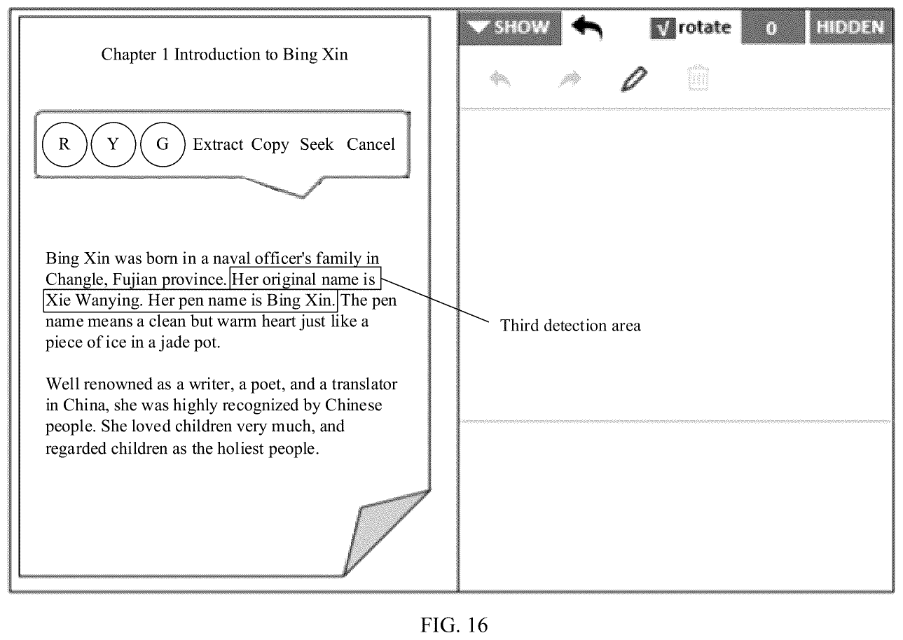

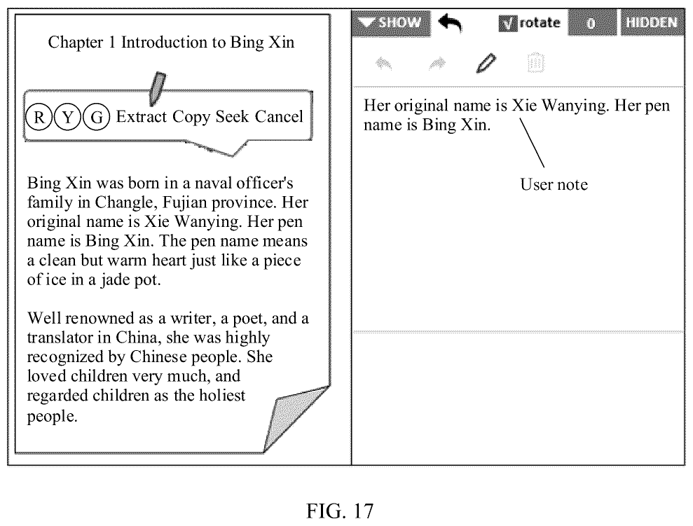

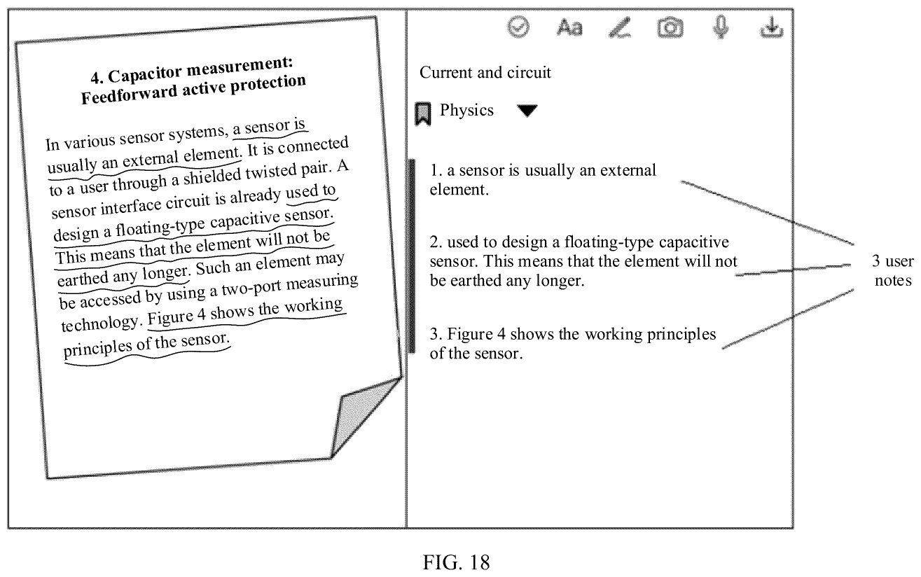

If the distance between the text area in the first detection area and the text area in the second detection area is less than the preset second threshold, it indicates that texts in the two text areas are the same note. Therefore, the terminal device may merge the first detection area and the second detection area into a third detection area, and identify a text area in the third detection area to obtain a user note. It needs to be noted that a sum of a length of a long side of the first detection area and a length of a long side of the second detection area is generally less than or equal to a length of a long side of the third detection area, because the first detection area and the second detection area may be connected together, or may not be connected together (a minor text area, for example, a size of a punctuation mark or a size of one or two characters, may exist between text areas of the two detection areas). For example, as shown in FIG. 16 (FIG. 16 is a schematic diagram of a third detection area according to an embodiment of this application, and FIG. 16 is obtained by drawing based on FIG. 15), after generating the second detection area, the terminal device may merge the second detection area and the first detection area to obtain a third detection area. A text area enclosed by the third detection area is the text area marked by the third drawn line plus the text area marked by the first drawn line, that is, an area in which “Her original name is Xie Wanying. Her pen name is Bing Xin” is located. Next, as shown in FIG. 17 (FIG. 17 is another schematic diagram of a user note according to an embodiment of this application), after obtaining the third detection area, the terminal device may remind the user whether to perform text identification. Because the user taps “Extract” (that is, enters a text identification instruction), the terminal device performs OCR on a text area in the third detection area, and extracts the text “Her original name is Xie Wanying. Her pen name is Bing Xin” as a user note.

If the distance between the text area in the first detection area and the text area in the second detection area is greater than or equal to the preset second threshold, it indicates that texts in the two text areas are not the same note but two different notes. Therefore, the terminal device may identify the text area in the first detection area and the text area in the second detection area respectively to obtain two user notes.

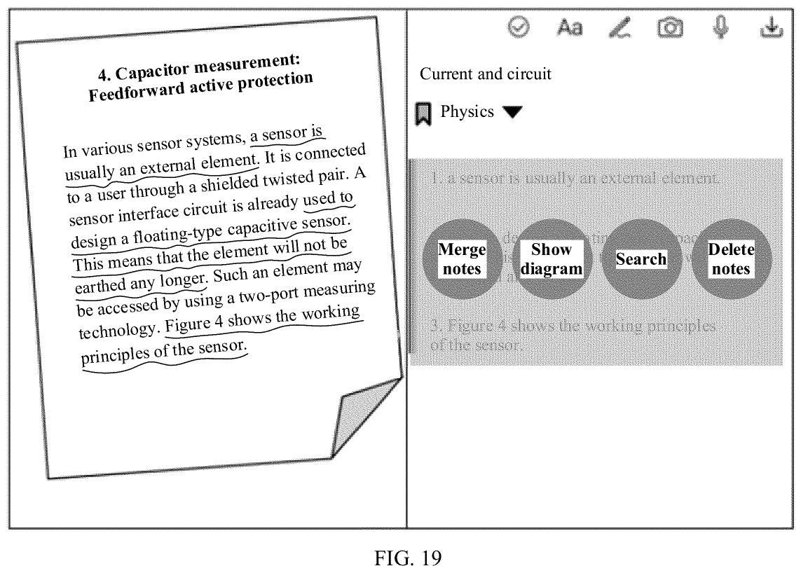

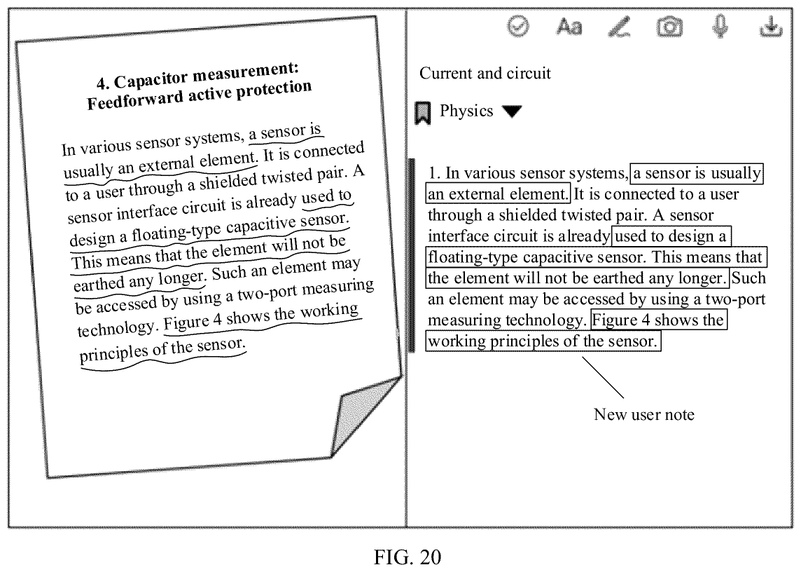

Further, after two different user notes are obtained, if the user enters a note merging instruction, the terminal device may detect, based on the note merging instruction, whether the two user notes are located in a same paragraph; and if the two user notes are located in a same paragraph, the terminal device may further merge the two user notes to obtain a new user note, where the new user note includes other texts other than the two user notes in the paragraph and the two user notes that are highlighted. For example, as shown in FIG. 18 to FIG. 20 (FIG. 18 is a schematic diagram of note merging according to an embodiment of this application, FIG. 19 is another schematic diagram of note merging according to an embodiment of this application, and FIG. 20 is still another schematic diagram of note merging according to an embodiment of this application), after three different notes are generated, the terminal device may remind the user whether to merge the notes. After the user taps “Merge notes” (equivalent to entering a note merging instruction), the terminal device may detect, based on the instruction, whether the three notes are located in a same paragraph. Because the three notes are located in a same paragraph, the terminal device may use the paragraph as a new note, and highlight texts of the original three notes in the new note.

It needs to be understood that, in this embodiment, for a process in which the terminal device performs OCR on the text area in the first detection area and the text area in the second detection area, or a process in which the terminal device performs OCR on the text area in the third detection area, refer to the process in which the terminal device performs OCR on the text area in the first detection area in the embodiment shown in FIG. 4. Details are not described herein again.

In this embodiment of this application, the terminal device may perform intention identification on a plurality of text areas marked by drawn lines, and determine, based on spatial information (a distance) between the plurality of text areas, whether texts in the plurality of text areas are a same note. After it is determined that the texts in the plurality of text areas are a plurality of different notes, a plurality of generated notes may be merged. In this way, a plurality of line drawing manners can be implemented for the user, for example, a manner of continuous line drawing and a manner of scattered line drawing in a same paragraph are supported, so that functions of the solution are more comprehensive, to further improve user experience.

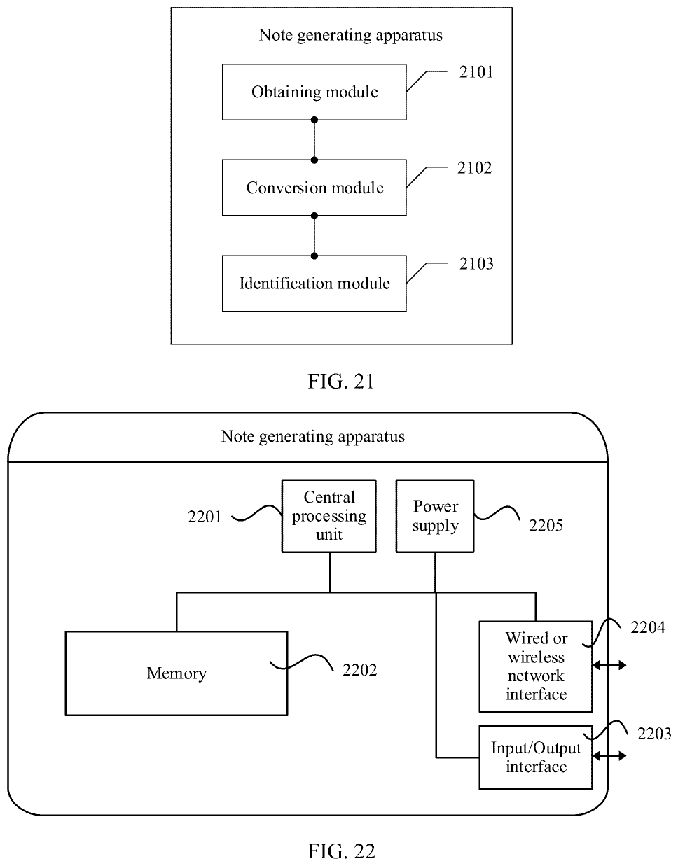

The foregoing is a detailed description of the note generating method provided in embodiments of this application. A note generating apparatus provided in embodiments of this application is described below. FIG. 21 is a schematic diagram of a structure of a note generating apparatus according to an embodiment of this application. As shown in FIG. 21, the apparatus includes:
an obtaining module 2101, configured to obtain a target text area in a first image frame, where the target text area is a text area being read by a user (that is, a to-be-identified text area);
a conversion module 2102, configured to convert a first drawn line in the target text area into a first detection area, where the first detection area is used to identify a text area marked by the first drawn line; and
an identification module 2103, configured to identify a text area in the first detection area to obtain a user note.

In embodiments of this application, after obtaining a text area that is in a first image frame and that is being read by a user, that is, after obtaining a target text area in the first image frame, a terminal device may identify a first drawn line entered by the user in the target text area, and convert the first drawn line in the target text area into a first detection area. Then the terminal device may perform OCR on a text area in the first detection area, to obtain a user note. In the foregoing process, the terminal device may intelligently convert the user-input first drawn line into the first detection area that identifies a text area marked by the first drawn line, to perform OCR on this part of text area in a targeted manner, to generate a note required by the user. It can be learned that, in this note generating manner, the user only needs to complete a line drawing operation, with a very small quantity of operations to be performed, and the user does not need to spend too much time, thereby improving user experience.

In a possible implementation, the conversion module is configured to: create a plurality of first rectangles that overlap with the first drawn line in the target text area, where the plurality of first rectangles are sequentially stacked; create a second drawn line in a first rectangle with a largest overlapping degree, where the second drawn line is parallel to a long side of the first rectangle with the largest overlapping degree; and create a second rectangle based on the second drawn line, where the second rectangle is used as the first detection area, the second drawn line is located in the second rectangle, the second drawn line is parallel to a long side of the second rectangle, and a length of a short side of the second rectangle is greater than a row height of the target text area.

In a possible implementation, the apparatus further includes an optimization module, configured to: divide the second rectangle into a plurality of sub-rectangles; and remove, from the plurality of sub-rectangles, a sub-rectangle whose pixel proportion is less than a preset first threshold, and use a third rectangle formed by remaining sub-rectangles as the first detection area.

In a possible implementation, the obtaining module is configured to: if state information about text areas in the first image frame is different from state information about text areas in a second image frame, determine the target text area in the first image frame based on the state information about the text areas in the first image frame, where the second image frame is an image frame previous to the first image frame.

In a possible implementation, the state information about the text areas includes at least one of the following: a quantity of the text areas, sizes of the text areas, angles of the text areas, and locations of the text areas.

In a possible implementation, the obtaining module is configured to: if there is a human body area of a user in the first image frame, compare a quantity of text areas in the first image frame with a quantity of text areas in the second image frame, to detect whether a new text area exists in the first image frame; and if a new text area exists in the first image frame, determine the new text area as the target text area; or if there is no new text area in the first image frame, determine a text area associated with the human body area as the target text area; or if there is no human body area of a user in the first image frame, determine a text area with a largest semantic size as the target text area, where a semantic size of a text area is a ratio of a size of the text area to a semantic distance of the text area, and the semantic distance of the text area is a distance between the text area and a central point of the first image frame.

In a possible implementation, a second detection area further exists in the target text area, the second detection area is obtained by converting a third drawn line in a third image frame, the third image frame is previous to the first image frame, and a plurality of image frames exist between the third image frame and the first image frame; and the identification module is configured to: if a distance between a text area in the first detection area and a text area in the second detection area is greater than or equal to a preset second threshold, respectively identify the text area in the first detection area and the text area in the second detection area to obtain two user notes; or if a distance between the text area in the first detection area and a text area in the second detection area is less than a preset second threshold, merge the first detection area and the second detection area into a third detection area, and identify a text area in the third detection area to obtain the user note.

In a possible implementation, the apparatus further includes a merging module, configured to merge the two user notes to obtain a new user note; the two user notes are located in a same paragraph; and the new user note includes other texts other than the two user notes in the paragraph and the two user notes that are highlighted.

In a possible implementation, the apparatus further includes a correction module, configured to correct the text area in the first detection area to obtain a corrected text area; and the identification module is configured to identify the corrected text area to obtain the user note.

In a possible implementation, a target symbol exists in the target text area, and the apparatus further includes a classification module, configured to: if the target symbol is included in a preset symbol set, add the user note to a user note set corresponding to the target symbol; or if the target symbol is not included in the symbol set, add the target symbol to the symbol set, create a user note set corresponding to the target symbol, and then add the user note to the user note set corresponding to the target symbol.

In a possible implementation, the first detection area is a first color block, and the first color block is used to cover the text area marked by the first drawn line.

In a possible implementation, a format of the user note is the same as formats of texts in the text areas of the detection areas.

In a possible implementation, a format of the user note is determined based on an instruction entered by the user, and the format of the user note includes at least one of the following: a font of the user note, a color of the user note, a thickness of the user note, a location of the user note, and a paragraph identifier of the user note.

In a possible implementation, the first image frame originates from media information.

It needs to be noted that, content such as information exchange between the modules/units of the apparatus and execution processes thereof are based on a same idea as the method embodiments of this application, and produce same technical effects as the method embodiments of this application. For specific content, refer to the foregoing descriptions in the method embodiments of this application. Details are not described herein again.

FIG. 22 is another schematic diagram of a structure of a note generating apparatus according to an embodiment of this application. As shown in FIG. 22, the note generating apparatus in this embodiment of this application may be used as the terminal device in FIG. 4 or FIG. 13. An embodiment of the terminal device may include one or more central processing units 2201, a memory 2202, an input/output interface 2203, a wired or wireless network interface 2204, and a power supply 2205.

The memory 2202 may be used for transient storage or persistent storage. Further, the central processing unit 2201 may be configured to communicate with the memory 2202, to perform a series of instruction operations in the memory 2202 on the terminal device.

In this embodiment, the central processing unit 2201 may perform operations performed by the terminal device in the embodiment shown in FIG. 4 or FIG. 13, and details are not described herein again.

In this embodiment, division of specific functional modules in the central processing unit 2201 may be similar to division of the obtaining module, the conversion module, the identification module, the optimization module, the merging module, the correction module, and the classification module described in FIG. 21, and details are not described herein again.

An embodiment of this application further relates to a computer storage medium, including computer-readable instructions. When the computer-readable instructions are executed, the steps performed by the terminal device in the embodiment shown in FIG. 4 or FIG. 13 are implemented.

An embodiment of this application further relates to a computer program product including instructions. When the computer program product is run on a computer, the computer is enabled to perform steps performed by the terminal device in the embodiment shown in FIG. 4 or FIG. 13.

It may be clearly understood by a person skilled in the art that, for the purpose of convenient and brief description, for detailed working processes of the foregoing systems, apparatuses, and units, refer to corresponding processes in the foregoing method embodiments. Details are not described herein again.

In the embodiments provided in this application, it needs to be understood that the disclosed systems, apparatuses, and methods may be implemented in other manners. For example, the described apparatus embodiments are merely examples. For example, division into units is merely logical function division. During actual implementation, there may be another division manner. For example, a plurality of units or components may be combined or integrated into another system, or some features may be ignored or not performed. In addition, the displayed or discussed mutual couplings or direct couplings or communications connections may be implemented by using some interfaces. Indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected depending on actual requirements to achieve the objectives of the solutions in the embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions of this application essentially, or the part contributing to a current technology, or all or some of the technical solutions may be implemented in the form of a software product. The computer software product is stored in a storage medium and includes several instructions for instructing a computer device (which may be a personal computer, a server, or a network device, or the like) to perform all or some of the steps of the methods described in embodiments of this application. The storage medium includes any medium that can store program code, such as a USB flash drive, a removable hard disk, a read-only memory (ROM, Read-Only Memory), a random access memory (RAM, Random Access Memory), a magnetic disk, or an optical disc.

1. A note generating method, wherein the method comprises:
obtaining a target text area in a first image frame, wherein the target text area is a to-be-identified text area;
converting a first drawn line in the target text area into a first detection area, wherein the first detection area is used to identify a text area marked by the first drawn line; and
identifying a text area in the first detection area to obtain a user note.

2. The method according to claim 1, wherein the converting a first drawn line in the target text area into a first detection area comprises:
creating a plurality of first rectangles that overlap with the first drawn line in the target text area, wherein the plurality of first rectangles are sequentially stacked;
creating a second drawn line in a first rectangle with a largest overlapping degree, wherein the second drawn line is parallel to a long side of the first rectangle with the largest overlapping degree; and
creating a second rectangle based on the second drawn line, wherein the second rectangle is used as the first detection area, the second drawn line is located in the second rectangle, the second drawn line is parallel to a long side of the second rectangle, and a length of a short side of the second rectangle is greater than a row height of the target text area.

3. The method according to claim 2, wherein after the creating a second rectangle based on the second drawn line, the method further comprises:
dividing the second rectangle into a plurality of sub-rectangles; and
removing, from the plurality of sub-rectangles, a sub-rectangle whose pixel proportion is less than a preset first threshold, and using a third rectangle formed by remaining sub-rectangles as the first detection area.

4. The method according to claim 1, wherein the obtaining a target text area in a first image frame comprises:
when state information about text areas in the first image frame is different from state information about text areas in a second image frame, determining the target text area in the first image frame based on the state information about the text areas in the first image frame, wherein the second image frame is an image frame previous to the first image frame.

5. The method according to claim 4, wherein the state information about the text areas comprises at least one of the following: a quantity of the text areas, sizes of the text areas, angles of the text areas, and locations of the text areas.

6. The method according to claim 4, wherein the determining the target text area in the first image frame based on the state information about the text areas in the first image frame comprises:
when there is a human body area of a user in the first image frame, comparing a quantity of text areas in the first image frame with a quantity of text areas in the second image frame, to detect whether a new text area exists in the first image frame; and
when a new text area exists in the first image frame, determining the new text area as the target text area; or
when there is no new text area in the first image frame, determining a text area associated with the human body area as the target text area; or
when there is no human body area of a user in the first image frame, determining a text area with a largest semantic size as the target text area, wherein a semantic size of a text area is a ratio of a size of the text area to a semantic distance of the text area, and the semantic distance of the text area is a distance between the text area and a central point of the first image frame.

7. The method according to claim 1, wherein a second detection area further exists in the target text area, the second detection area is obtained by converting a third drawn line in a third image frame, the third image frame is previous to the first image frame, and a plurality of image frames exist between the third image frame and the first image frame; and the identifying a text area in the first detection area to obtain a user note comprises:
when a distance between the text area in the first detection area and a text area in the second detection area is greater than or equal to a preset second threshold, respectively identifying the text area in the first detection area and the text area in the second detection area to obtain two user notes; or
when a distance between the text area in the first detection area and a text area in the second detection area is less than a preset second threshold, merging the first detection area and the second detection area into a third detection area, and identifying a text area in the third detection area to obtain the user note.

8. The method according to claim 7, wherein after the respectively identifying the text area in the first detection area and the text area in the second detection area to obtain two user notes, the method further comprises:
merging the two user notes to obtain a new user note, wherein the two user notes are located in a same paragraph, and the new user note comprises other texts other than the two user notes in the paragraph and the two user notes that are highlighted.

9. (canceled)

10. The method according to claim 1, wherein a target symbol exists in the target text area, and after the identifying a text area in the first detection area to obtain a user note, the method further comprises:
when the target symbol is comprised in a preset symbol set, adding the user note to a user note set corresponding to the target symbol; or
when the target symbol is not comprised in the symbol set, adding the target symbol to the symbol set, creating a user note set corresponding to the target symbol, and then adding the user note to the user note set corresponding to the target symbol.

11. The method according to claim 1, wherein the first detection area is a first color block, and the first color block is used to cover the text area marked by the first drawn line, and
wherein a format of the user note is determined based on an instruction entered by the user, and the format of the user note comprises at least one of the following: a font of the user note, a color of the user note, a thickness of the user note, a location of the user note, and a paragraph identifier of the user note.

12-13. (canceled)

14. A note generating apparatus, wherein the apparatus comprises:
an obtaining module, configured to obtain a target text area in a first image frame, wherein the target text area is a to-be-identified text area, and the first image frame originates from media information;
a conversion module, configured to convert a first drawn line in the target text area into a first detection area, wherein the first detection area is used to identify a text area marked by the first drawn line; and
an identification module, configured to identify a text area in the first detection area to obtain a user note.

15. The apparatus according to claim 14, wherein the conversion module is configured to:
create a plurality of first rectangles that overlap with the first drawn line in the target text area, wherein the plurality of first rectangles are sequentially stacked;
create a second drawn line in a first rectangle with a largest overlapping degree, wherein the second drawn line is parallel to a long side of the first rectangle with the largest overlapping degree; and
create a second rectangle based on the second drawn line, wherein the second rectangle is used as the first detection area, the second drawn line is located in the second rectangle, the second drawn line is parallel to a long side of the second rectangle, and a length of a short side of the second rectangle is greater than a row height of the target text area.

16. The apparatus according to claim 15, wherein the apparatus further comprises an optimization unit, configured to:
divide the second rectangle into a plurality of sub-rectangles; and
remove, from the plurality of sub-rectangles, a sub-rectangle whose pixel proportion is less than a preset first threshold, and use a third rectangle formed by remaining sub-rectangles as the first detection area.

17. The apparatus according to claim 14, wherein the obtaining module is configured to: when state information about text areas in the first image frame is different from state information about text areas in a second image frame, determine the target text area in the first image frame based on the state information about the text areas in the first image frame; and the second image frame is an image frame previous to the first image frame.

18. The apparatus according to claim 17, wherein the state information about the text areas comprises at least one of the following: a quantity of the text areas, sizes of the text areas, angles of the text areas, and locations of the text areas.

19. The apparatus according to claim 17, wherein the obtaining module is configured to:
when there is a human body area of a user in the first image frame, compare a quantity of text areas in the first image frame with a quantity of text areas in the second image frame, to detect whether a new text area exists in the first image frame; and
when a new text area exists in the first image frame, determine the new text area as the target text area; or
when there is no new text area in the first image frame, determine a text area associated with the human body area as the target text area; or
when there is no human body area of a user in the first image frame, determine a text area with a largest semantic size as the target text area, wherein a semantic size of a text area is a ratio of a size of the text area to a semantic distance of the text area, and the semantic distance of the text area is a distance between the text area and a central point of the first image frame.

20. The apparatus according to claim 17, wherein a second detection area further exists in the target text area, the second detection area is obtained by converting a third drawn line in a third image frame, the third image frame is previous to the first image frame, and a plurality of image frames exist between the third image frame and the first image frame; and the identification module is configured to:
when a distance between a text area in the first detection area and a text area in the second detection area is greater than or equal to a preset second threshold, respectively identify the text area in the first detection area and the text area in the second detection area to obtain two user notes; or
when a distance between the text area in the first detection area and a text area in the second detection area is less than a preset second threshold, merge the first detection area and the second detection area into a third detection area, and identify a text area in the third detection area to obtain the user note.

21. The apparatus according to claim 20, wherein the apparatus further comprises a merging module, configured to merge the two user notes to obtain a new user note; the two user notes are located in a same paragraph; and the new user note comprises other texts other than the two user notes in the paragraph and the two user notes that are highlighted.

22. (canceled)

23. The apparatus according to claim 14, wherein a target symbol exists in the target text area, and the apparatus further comprises a classification module, configured to:
when the target symbol is comprised in a preset symbol set, add the user note to a user note set corresponding to the target symbol; or
when the target symbol is not comprised in the symbol set, add the target symbol to the symbol set, create a user note set corresponding to the target symbol, and then add the user note to the user note set corresponding to the target symbol.

24. The apparatus according to claim 14, wherein the first detection area is a first color block, and the first color block is used to cover the text area marked by the first drawn line, and
wherein a format of the user note is determined based on an instruction entered by the user, and the format of the user note comprises at least one of the following: a font of the user note, a color of the user note, a thickness of the user note, a location of the user note, and a paragraph identifier of the user note.

25-29. (canceled)
